(19) United States
(12) Patent Application Publication
(10) Pub. No.: US 2017/0103574 A1
(43) Pub. Date: Apr. 13, 2017

(54) SYSTEM AND METHOD FOR PROVIDING CONTINUITY BETWEEN REAL WORLD MOVEMENT AND MOVEMENT IN A VIRTUAL/AUGMENTED REALITY EXPERIENCE

(71) Applicant: Google Inc., Mountain View, CA (US)

(72) Inventors: Alexander James Faaborg, Mountain View, CA (US); Chris McKenzie, Brooklyn, NY (US); Adam Glazier, Oakland, CA (US)

(21) Appl. No.: 14/881,827

(22) Filed: Oct. 13, 2015

(51) Int. Cl. G06T 19/00; G02B 27/01; G06F 3/01

(52) U.S. Cl. CPC G06T 19/006; G06F 3/012; G06F 3/013; G02B 27/0172

(57) ABSTRACT

A system and method of operating an audio visual system generating an immersive virtual experience may detect when a user approaches a physical boundary of a real world space, and may generate an alert indicating the proximity of the physical boundary. Activity in and interaction with the immersive virtual experience may be temporarily paused as the user completes a physical re-orientation in the real world space in response to the alert. Upon detection of completion of the physical re-orientation in the real world space, activity in and interaction with the immersive virtual experience may resume at the point at which activity was temporarily paused. This may provide for relatively continuous movement in the immersive virtual experience within the boundaries of the real world space.

### FIELD

This document relates, generally, to a virtual or augmented reality system.

### BACKGROUND

In an immersive experience, such as an experience generated by a Virtual Reality (VR) system or an Augmented Reality (AR) system, boundaries in a real world environment may affect a user's ability to fully experience a continuous virtual world environment generated by the system. Continuity in the virtual world when encountering a real world boundary may enhance the user's sense of presence and immersion in the virtual world. Existing systems and methods do not provide for this type of continuity.

### SUMMARY

In one aspect, a method, may include generating a virtual world environment within an audio visual device, detecting, at the audio visual device, a physical boundary in a real world environment in response to move of the audio visual device within the real world environment, generating an alert in response to the detecting of the physical boundary, pausing activity in the virtual world environment during physical re-orientation of the audio visual device within the real world environment, and resuming activity in the virtual world upon completion of the re-orientation of the audio visual device within the real world environment.

In another aspect, an audio visual device may include a head mounted electronic device configured to be operably coupled with a handheld electronic device, the head mounted electronic device including a display, an optical tracking device, and a control system controlling operation of the head mounted electronic device to display a virtual world environment on the display, detect a physical boundary in the real world environment, generate an alert in response to the detection of the physical boundary, and re-orient the virtual world environment in coordination with a physical re-orientation of the head mounted electronic device in the real world environment.

In another aspect, in a non-transitory computer-readable storage medium storing instructions that, when executed, cause a computing device to perform a process, the instructions may include instructions to operate a head mounted electronic device within physical boundaries of a real world environment to generate an immersive virtual environment, detect a physical boundary of the real world environment, generate an alert in response to the detection of the physical boundary, the alert including a virtual visual indicator displayed on a display of the head mounted electronic device, pause activity in the virtual world environment in response to detection of initiation of a physical re-orientation of the head mounted electronic device in the real world space, track a physical position and orientation of the head mounted electronic device in the real world space, and resume activity in the virtual world environment, at the same point at which activity was paused, in response to detection of completion of a physical re-orientation of the head mounted electronic device in the real world space

The details of one or more implementations are set forth in the accompanying drawings and the description below. Other features will be apparent from the description and drawings, and from the claims.

### BRIEF DESCRIPTION OF THE DRAWINGS

FIG. 1 is an example implementation of a virtual reality system.

FIGS. 2A and 2B are perspective views of a head mounted display device, in accordance with an embodiment broadly described herein.

FIG. 3 is a block diagram of a system providing for continuity between real world physical movement and movement in an immersive virtual experience generated by a virtual reality system, in accordance with an embodiment broadly described herein.

FIGS. 4A-4D illustrate an example implementation of a system for facilitating a re-orientation in an immersive virtual experience, in accordance with an embodiment broadly described herein.

FIG. 5 is a flowchart of a method of facilitating a re-orientation in an immersive virtual experience, in accordance with an embodiment as broadly described herein.

FIGS. 6A-6F illustrate an example implementation of a system for facilitating a re-orientation in an immersive virtual experience, in accordance with an embodiment broadly described herein.

FIGS. 7A-4D illustrate an example implementation of a system for facilitating a re-orientation in an immersive virtual experience, in accordance with an embodiment broadly described herein.

FIG. 8 is a flowchart of a method of facilitating a re-orientation in an immersive virtual experience, in accordance with an embodiment as broadly described herein.

FIG. 9 illustrates an example of a computer device and a mobile computer device that can be used to implement the techniques described here.

### DETAILED DESCRIPTION

A Virtual Reality (VR) system and/or an Augmented Reality (AR) system may include, for example, a head mounted display (HMD) device or similar device worn by a user, for example, on a head of the user, to generate an immersive virtual world environment to be experienced by the user. Movement of the user in the real world environment may be translated into corresponding movement in the virtual world environment. Differences in the physical boundaries of the real world, such as, for example, the confines of a room and/or objects in the room, may disrupt the user's movement in what may otherwise be a seemingly endless virtual world. A substantially continuous, uninterrupted virtual experience as the user moves and encounters one of these physical boundaries in the real world may avoid disorientation and/or other discomfort such as, for example, motion sickness, which may occur as a user immersed in the virtual world encounters a real world boundary and must reorient in order to continue to move in the virtual world. A virtual reality system in which a user may move seemingly endlessly within the fixed confines of a real world space may also enhance a user's enjoyment of and immersion in the virtual world.

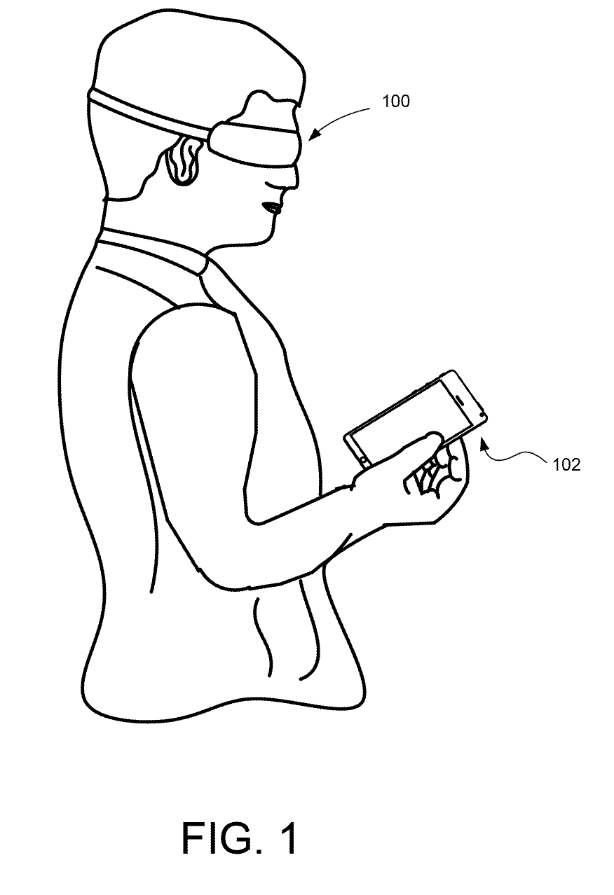

In the example implementation shown in FIG. 1, a user wearing an HMD 100 is holding a portable, or handheld, electronic device 102, such as, for example, a smartphone, or other portable handheld electronic device that may be paired with, or operably coupled with, and communicate with, the HMD 100 via, for example, a wired connection, or a wireless connection such as, for example, a wifi or Bluetooth connection. This pairing, or operable coupling, may provide for communication and exchange of data between the handheld electronic device 102 and the HMD 100, so that the handheld electronic device 102 may function as a controller in communication with the HMD 100 for interacting in the immersive virtual world experience generated by the HMD 100. In the example shown in FIG. 1, the user is holding the handheld electronic device 102 with his right hand. However, the user may also hold the handheld electronic device 102 in his left hand, or in both his left hand and his right hand, and still interact with the immersive virtual world experience generated by the HMD 100

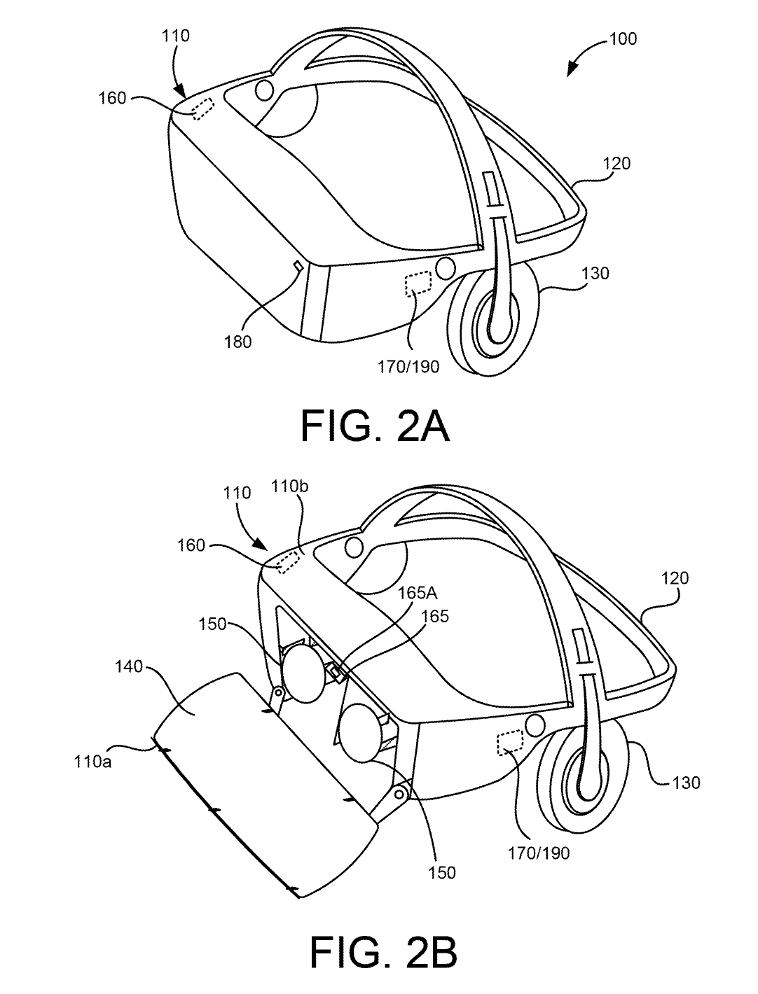

FIGS. 2A and 2B are perspective views of an example HMD, such as, for example, the HMD 100 worn by the user in FIG. 1, to generate an immersive virtual experience. The HMD 100 may include a housing 110 coupled, for example, rotatably coupled and/or removably attachable, to a frame 120. An audio output device 130 including, for example, speakers mounted in headphones, may also be coupled to the frame 120. In FIG. 2B, a front face 110a of the housing 110 is rotated away from a base portion 110b of the housing 110 so that some of the components received in the housing 110 are visible. A display 140 may be mounted on the front face 110a of the housing 110. Lenses 150 may be mounted in the housing 110, between the user's eyes and the display 140 when the front face 110a is in the closed position against the base portion 110b of the housing 110. A position of the lenses 150 may be may be aligned with respective optical axes of the user's eyes to provide a relatively wide field of view and relatively short focal length. In some embodiments, the HMD 100 may include a sensing system 160 including various sensors and a control system 170 including a processor 190 and various control system devices to facilitate operation of the HMD 100.

In some embodiments, the HMD 100 may include a camera 180 to capture still and moving images of the real world environment outside of the HMD 100. In some embodiments the images captured by the camera 180 may be displayed to the user on the display 140 in a pass through mode, allowing the user to temporarily view the real world without removing the HMD 100 or otherwise changing the configuration of the HMD 100 to move the housing 110 out of the line of sight of the user.

In some embodiments, the HMD 100 may include an optical tracking device 165 to detect and track user eye movement and activity. The optical tracking device 165 may include, for example, an image sensor 165A to capture images of the user's eyes, and in some embodiments, a particular portion of the user's eyes, such as, for example, the pupil. In some embodiments, the optical tracking device 165 may include multiple image sensors 165A positioned to detect and track user eye activity. In some embodiment, the optical tracking device 165 may detect and track optical gestures such as, for example eyelid movement associated with opening and/or closing of the user's eyes (e.g., closing for a threshold period of time and then opening, opening for a threshold period of time and then closing, closing and/or opening in particular pattern). In some embodiments, the optical tracking device 165 may detect and track an eye gaze direction and duration. In some embodiments, the HMD 100 may be configured so that the optical activity detected by the optical tracing device 165 is processed as a user input to be translated into a corresponding interaction in the immersive virtual world experience generated by the HMD 100.

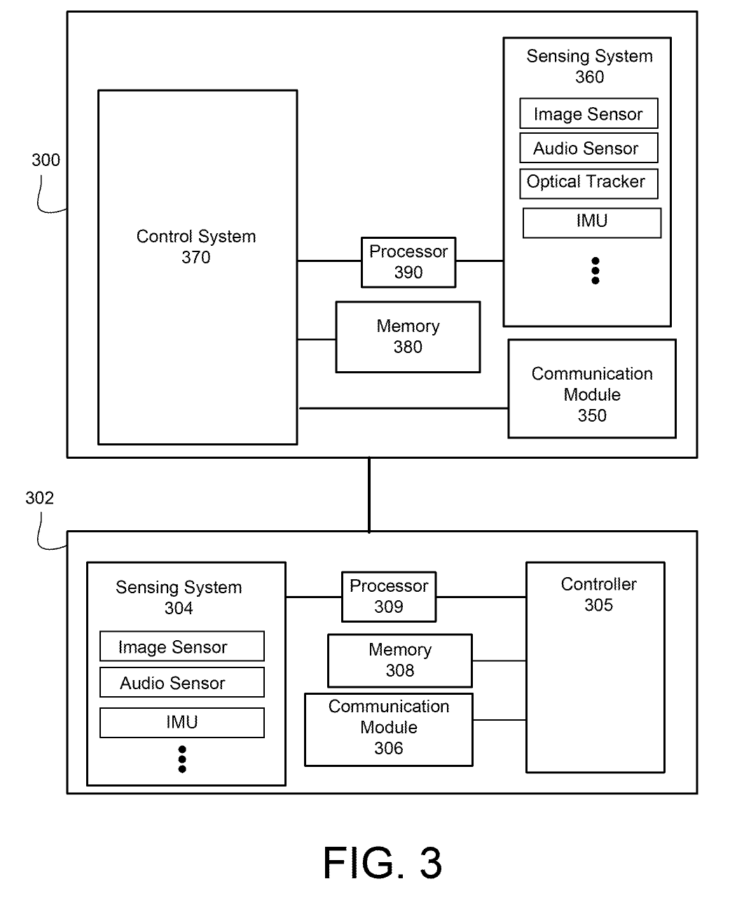

A block diagram of a system providing for continuity of movement between the real world and the virtual world in a virtual reality system operating in a defined real world space is shown in FIG. 3. The system may include a first user electronic device 300. In some embodiments, the first user electronic device 300 may be in communication with a second user electronic device 302. The first user electronic device 300 may be, for example an HMD as described above with respect to FIGS. 1, 2A and 2B, generating an immersive virtual immersive experience, and the second user electronic device 302 may be, for example, a handheld electronic device as described above with respect to FIG. 1, in communication with the first user electronic device 300 to facilitate user interaction with the virtual immersive experience generated by the HMD.

The first electronic device 300 may include a sensing system 360 and a control system 370, which may be similar to the sensing system 160 and the control system 170, respectively, shown in FIGS. 2A and 2B. The sensing system 360 may include numerous different types of sensors, including, for example, a light sensor, an audio sensor, an image sensor, a distance/proximity sensor, an inertial measurement system including for example and accelerometer and gyroscope, and/or other sensors and/or different combination(s) of sensors. In some embodiments, the light sensor, image sensor and audio sensor may be included in one component, such as, for example, a camera, such as the camera 180 of the HMD 100 shown in FIGS. 2A and 2B. In some embodiments, the sensing system 360 may include an image sensor positioned to detect and track optical activity of the user, such as, for example, a device similar to the optical tracking device 165 shown in FIG. 2B. The control system 370 may include numerous different types of devices, including, for example, a power/pause control device, audio and video control devices, an optical control device, a transition control device, and/or other such devices and/or different combination(s) of devices. In some embodiments, the sensing system 360 and/or the control system 370 may include more, or fewer, devices, depending on a particular implementation. The elements included in the sensing system 360 and/or the control system 370 can have a different physical arrangement (e.g., different physical location) within, for example, an HMD other than the HMD 100 shown in FIGS. 2A and 2B.

The first electronic device 300 may also include a processor 390 in communication with the sensing system 360 and the control system 370, a memory 380 accessible by, for example, a module of the control system 370, and a communication module 350 providing for communication between the first electronic device 300 and another, external device, such as, for example, the second electronic device 302 paired to the first electronic device 300.

The second electronic device 302 may include a communication module 306 providing for communication between the second electronic device 302 and another, external device, such as, for example, the first electronic device 300 paired with the second electronic device 302. In addition to providing for the exchange of, for example, electronic data between the first electronic device 300 and the second electronic device 302, in some embodiments, the communication module 306 may also be configured to emit a ray or beam. The second electronic device 302 may include a sensing system 304 including, for example, an image sensor and an audio sensor, such as is included in, for example, a camera and microphone, an inertial measurement unit, a touch sensor such as is included in a touch sensitive surface of a handheld electronic device, and other such sensors and/or different combination(s) of sensors. A processor 309 may be in communication with the sensing system 304 and a controller 305 of the second electronic device 302, the controller 305 having access to a memory 308 and controlling overall operation of the second electronic device 302.

In some embodiments, in a virtual reality system, a user may physically move in a prescribed physical space, or real world space, in which the system is received and operated. The system may track the user's movement in the real world space, and cause movement in the virtual world in coordination with the user's movement in the real world. In other words, the movement of the user in the real world space may be translated into movement in the virtual world to generate a heightened sense of presence in the virtual world. Simply for ease of discussion and illustration, the real world space will hereinafter be considered a room, having walls, a floor and a ceiling defining the physical boundaries of the real world space. In contrast, the virtual world may be essentially without boundary, with the user's virtual movement in the virtual world only limited by the confines, or boundaries of the room in which the virtual reality system is operated.

In some embodiments, the boundaries of the room, for example, the relative positioning of the walls, may be known by the virtual reality system. This may be accomplished by, for example, a scan of the room upon initiation of a virtual immersive experience and calibration of the relative positions of the walls, installation of the virtual reality system in a room having a standard and/or known configuration, and the like. In some embodiments, the virtual reality system may be set to detect physical boundaries such as walls or other objects (e.g., chair, desk, table, bed, couch, etc.) as the user approaches.

In some embodiments, once a physical configuration of the room in which the virtual reality system is operated is known (including boundaries defined by walls), a size, or extent, of the virtual world environment may simply be designed and/or adapted to fit within the confines or boundaries of the physical space in which the virtual reality system is operated. However, this may be unnecessarily limiting on a system capable of generating a significantly more extensive virtual world environment otherwise capable of accommodating more extensive user movement and exploration.

In some embodiments, as the user's movement in the real world is translated into movement in the virtual world, and approaches a wall (either known or detected real time by the system), the system may cause the virtual world to automatically scroll as the user turns in an effort to re-orient within the space to accommodate further movement. This scrolling of the virtual world may effectively re-orient the user and allow the user to resume movement, but in the interim may cause disorientation and/or other discomfort such as, for example, motion sickness due to the physical and visual mismatch(es) between the real world and the virtual world.

In some embodiments, as the user moves in the real world and correspondingly in the virtual world, and approaches an object, such as, for example, a wall (either known or detected real time by the system), the system may generate an alert, for example, a visual alert in the form of a grid overlaid on the display of the virtual world or other type of visual indicator, and/or an audible indicator such as a tone and the like. In response to the alert, the user may use a pointing device, such as, for example a beam or ray emitted by the handheld electronic device, to point in a new direction (away from the wall), causing the current virtual environment to gradually fade out and the newly selected virtual environment to fade in. While this may cause the user to “teleport” to another portion of the virtual environment upon encountering the wall, the user remains at the wall and must still turn or shift to continue to move in the virtual environment, causing some of the disorientation and/or motion sickness noted above.

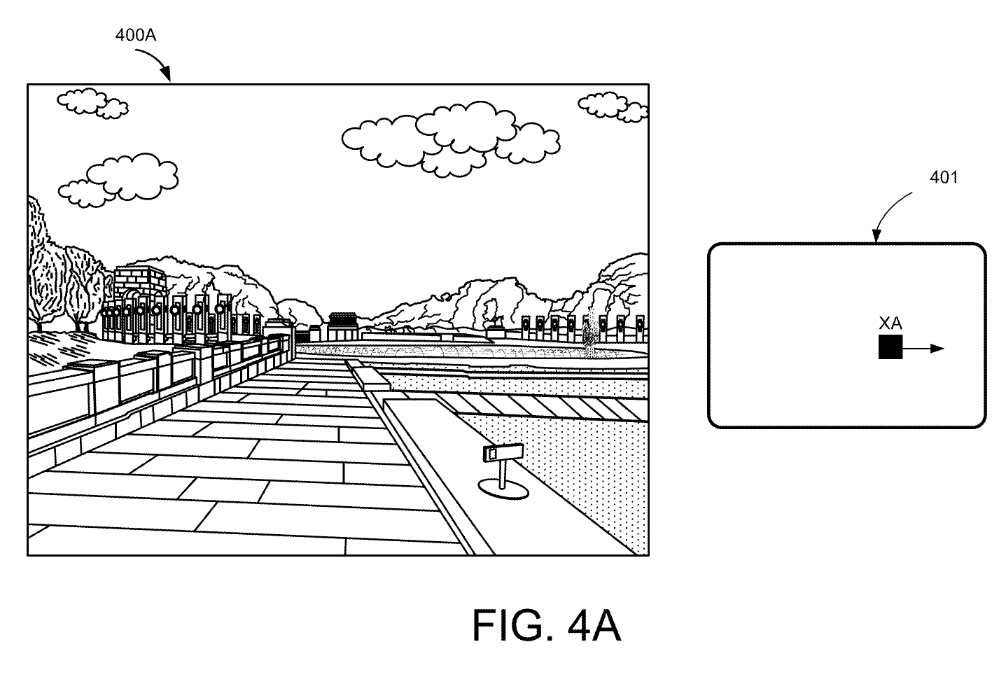

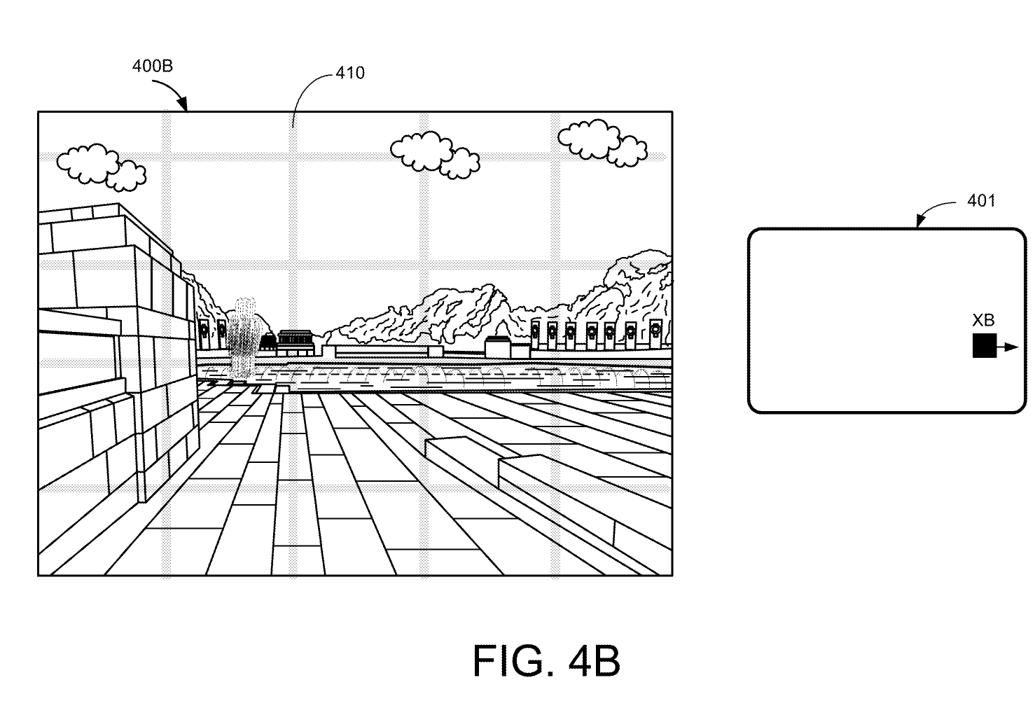

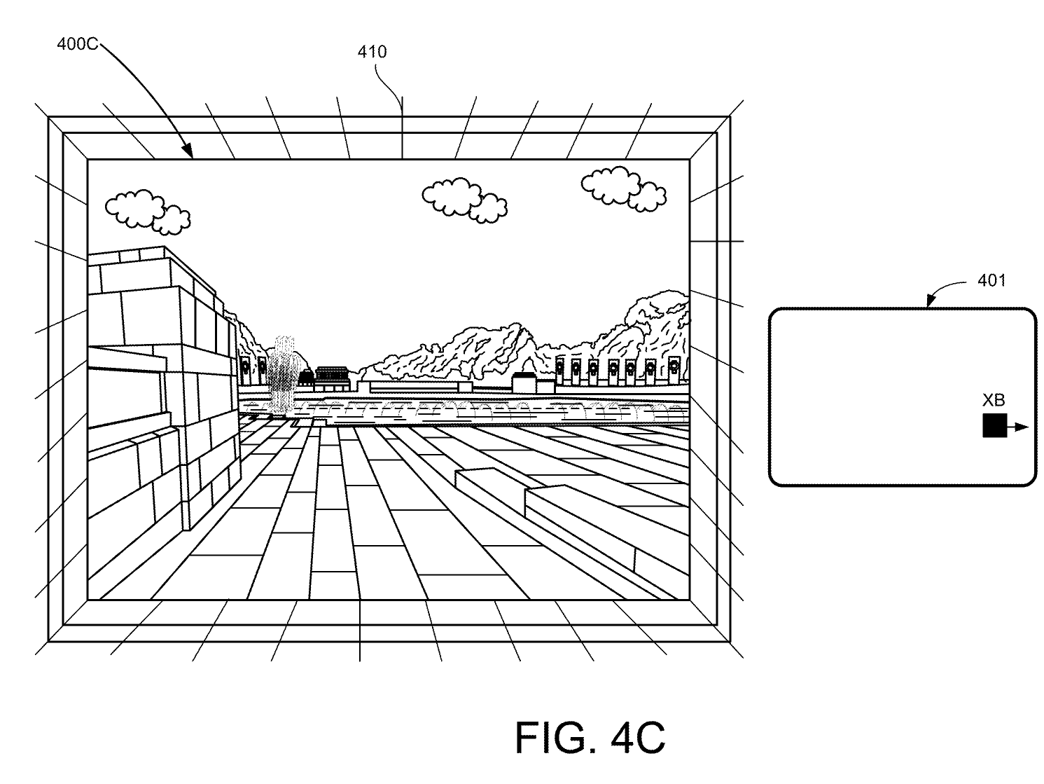

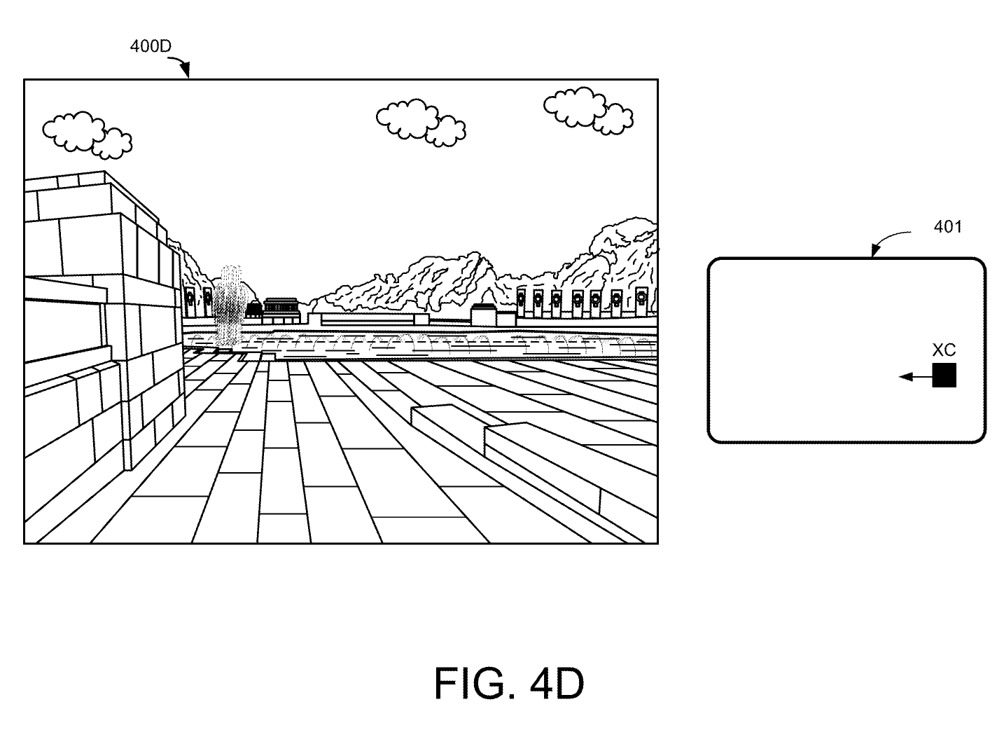

In a system and method, in accordance with embodiments as broadly described herein, the user may move in the real world, and that real world movement may be translated into corresponding movement in the virtual world. An example of a scene 400A, as viewed by the user, for example, on the display 140 of the HMD 100, as the user moves in the real world space 401, and correspondingly in the virtual world scene 400A, is shown in FIG. 4A. In FIG. 4A, the user is at position XA, and moving in the direction of the arrow. As the user continues to move and approaches a wall defining a boundary of the real world space 401, or room, (either known or detected real time by the system), to position XB, the system may generate an alert, for example, a visual alert in the form of a grid overlaid on the display of the virtual world, or other type of visual indicator, and/or an audible indicator such as a tone and the like. An example scene 400B as viewed by the user, as the user moves toward position XB and approaches the wall, is shown in FIG. 4B. In the scene 400B shown in FIG. 4B, a visual alert in the form of a grid 410 is displayed on the virtual scene 400B, warning the user that the user is, for example, within a predetermined range of the wall, or has essentially reached the wall.

In some embodiments, the grid 410 may be essentially overlaid on the scene 400B as shown in FIG. 4B. In some embodiments, a three dimensional grid 410C may surround the scene 400C, as shown in FIG. 4C, to give the impression of depth and/or relative distance from the wall. As noted above, in some embodiments, the alert may be a visual indicator in a different form, and/or may include an audible indicator in addition to or instead of the visual indicator.

The alert may serve as an indicator to the user that the user is at or near the wall, and although the virtual world environment may continue relatively unbounded, boundaries of the real world space defined by the walls of the room may inhibit the user's further movement in the real world, and thus further movement in the virtual world without a physical re-orientation of the user in the real world space. In some embodiments, in response to the alert indicating that the user is at or near the wall, the user may trigger a shift in the orientation of the virtual world, in coordination with a physical re-orientation of the user, so that the user may continue to move and interact in the virtual world, essentially uninterrupted.

In some embodiments, this shift may be triggered by optical activity that is captured by, for example, a device such as the optical tracking device 165 of the HMD 100 shown in FIGS. 2A-2B and 3. For example, as the user views the scene 400A shown in FIG. 4A, the alert in the form of the grid 410 may be displayed on the scene 400B or 400C as the user approaches the wall as shown in FIGS. 4B or 4C. In response to receiving the alert/seeing the grid 410 displayed, the user may stop walking, and close his eyes, and pivot or turn away from the wall a sufficient amount so that the area in the space in front of the user is open and the user is able to resume movement/walking in the room. For example, in some embodiments, the user may turn approximately 180 degrees, so that upon completion of the turn the wall is behind the user. In some embodiments, the user may turn more than 180 degrees. In some embodiments, the user may turn less than 180 degrees. Upon completion of the turn, the user may open his eyes. This shift is shown in FIG. 4D, in which the user has re-oriented at position XC, and is able to move relatively unobstructed in the real world space 401 in the direction of the arrow.

The closing of the user's eyes prior to initiating the turn may be captured by the optical tracking device 165, and may trigger a pause (e.g., a suspension, a stop, a slow-down) in activity in the immersive virtual experience, in particular related to movement as the user turns away from the wall. The opening of the user's eyes upon completing the turn may also be captured by the optical tracking device 165, and may cause the system to resume activity in the immersive virtual experience from the point at which activity was paused. Thus, upon opening his/her eyes, the user may view a scene 400D, as shown in FIG. 4D, that is essentially the same as the scene 400B/400C last viewed before closing his/her eyes and initiating the turn to physically re-orient in the real world space 401. However, after completion of the turn, the user at position XC is facing a more open portion of the room, for example a central portion of the room, rather than the wall. The relatively open real world space in front of the user may allow the user to resume walking in the real world, with corresponding movement in the virtual world.

This pause in activity in the virtual world, while the user executes the turn with eyes closed, may allow the user to resume activity with little to no perceived change in visual orientation in the virtual world. That is, the virtual world appears the same to the user upon opening his/her eyes as it appeared when closing his/her eyes. Thus the user has been re-oriented in the real world space, but remains in the same place in the virtual world. This change in physical direction, to allow the user to resume movement, made with eyes closed may be perceived by the user as a relatively seamless and relatively quick pause. Further, as the change is made with eyes closed, there is no mismatch between what the user “sees” in the virtual world and what the user “feels” in regards to motion, which may help avoid the disorientation and/or motion sickness associated with other forms of transition.

In some situations, it may be difficult for the user to judge a distance traveled during a pivot, or turn, particularly with eyes closed, and/or to judge completion of the turn. To facilitate proper completion of the pivot or turn, to provide open space for continued movement in front of the user upon completion of the turn, in some embodiments, a sensor of the HMD 100, such as, for example, the IMU, and/or a sensor of the handheld electronic device 102 such as, for example the IMU, and or camera(s) on the HMD 100 and/or the handheld electronic device 102, and/or other sensors throughout the real world space, may detect and track the user's movement through the pivot/turn. In some embodiments, this detection and tracking may be triggered in response to detection of the eye close by the optical tracking device 165, together with the pause in activity in the virtual world that is triggered by the detection of the eye close by the optical tracking device 165.

In some embodiments, the HMD 100 and/or the handheld electronic device 102 may generate an alert upon detection of completion of a pivot or turn. The alert may be, for example an audible alert such as a tone emitted by the HMD 10 and/or the handheld electronic device 102, a tactile alert such as a vibration emitted by the HMD 100 and/or the handheld electronic device 102, or other alert perceptible by the user with eyes closed. This alert of completion of the pivot or turn generated by the HMD 100 and/or the handheld electronic device 102 may trigger the user to open his/her eyes, which may be detected by the optical tracking device 165 and in turn trigger activity to resume in the virtual world as described above.

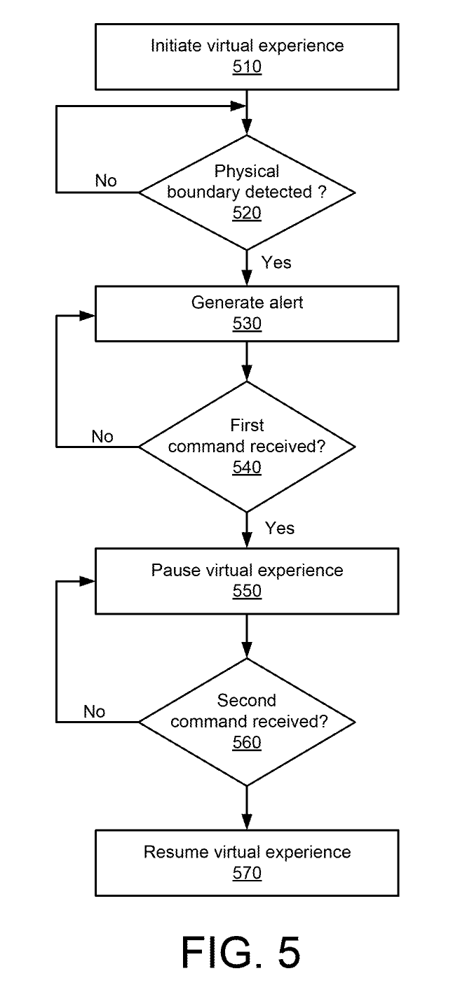

A flowchart of the process described above with respect to FIGS. 4A-4D is shown in FIG. 5. First, at block 510, a virtual immersive experience may be initiated by, for example, a first electronic device such as the HMD 100 shown in FIGS. 1 and 2A-2B, operably coupled with, for example, a second electronic device such as the handheld electronic device 102 shown in FIG. 1. As noted above, this operable coupling may be achieved through, for example, a wired connection or a wireless connection, to facilitate communication and exchange of information between the first and second electronic devices. As described above, in some embodiments, the virtual reality system may be operated, for example, in a real world space, or room, having physical boundaries such as walls, a floor and a ceiling.

In some embodiments, the optical tracking device 165 may detect the closing of the user's eyes as a deliberate closing intended to trigger a pause in activity in the virtual world, and may detect the opening of the user's eyes as deliberate opening intended to trigger activity to resume in the virtual world, and may distinguish the deliberate closing and opening of eyes from an involuntary blink.

When a physical boundary of the real world space, or room, is detected by the system, at block 520, the system may generate an alert, at block 530, alerting the user to the proximity of the physical boundary which may limit the user's ability to continue to physically move, or walk, in the real world space, thus also limiting further mobility in the virtual world. As noted above, in some embodiments, the physical boundaries, or walls, of the real world space may be standard, or pre-set. In some embodiments, the physical boundaries, or walls, of the real world space may be set by the system upon initiation of the virtual immersive experience by, for example, scanning the real world space. In some embodiments, the physical boundaries, or walls, of the real world space may be detected by the system essentially real time with the system essentially continuously, or periodically, scanning the real world space. As described above, in some embodiments, the alert may be, for example, a visual indicator and/or an audible indicator and/or other type of indicator. In some embodiments, the visual indicator may include, for example, a grid overlaid on and/or extending from the virtual scene generated and displayed so as to be visible to the user. In some embodiments, the audible indicator may include, for example, a tone or other type of audible warning. In some embodiments, the alert may include a tactile or physical indicator, such as, for example, vibration of the HMD 100 and/or the handheld electronic device 102. In some embodiments, the alert may include other types of indicators, based on, for example, factors associated with a particular virtual world and/or factors associated with a particular real world space.

If, in response to the alert (visual indicator and/or audible indicator and/or other type of indicator), the system receives a first command, at block 540, the system may essentially pause activity in the virtual world experience, at block 550. This essential pause in activity in the immersive virtual experience experience may allow the user to shift, or re-orient, in the real world space, to allow for continued physical movement in the real world space, and corresponding movement in the virtual world, and then resume activity in the immersive virtual experience where the user left off. As described above, in some embodiments, the first command, causing a pause in activity in the immersive virtual experience may be, for example, a closing of the user's eyes detected by, for example, the optical tracking device 165 of the HMD 100 as described above. In some embodiments, the first command, causing an essential pause in activity in the immersive virtual experience may be, for example, a physical manipulation of the HMD 100 and/or the handheld electronic device, an audible command issued by the user, or other command that may be received by the system. Simply for ease of discussion and illustration, the first command will be considered to be the closing of the user's eyes detected by the optical tracking device 165 of the HMD 100 as described above.

As described above, upon receiving the first command (for example, detection of the closing of the user's eyes), the user may initiate a turn, to physically re-orient in the real world space and allow for continued movement in the real world space and corresponding movement in the virtual world. As noted above, in some embodiments, this may include a turn in a direction away from the detected physical boundary, or wall, and back toward an open portion, for example, a central portion, of the real world space. In some embodiments, the turn may be, for example, approximately 180 degrees. In some embodiments, the turn may be, for example, greater than 180 degrees, or less than 180 degrees. As the turn may be executed with the user's eyes closed, to facilitate an essentially seamless and continuous immersive virtual experience, in some embodiments, the system, for example, the HMD 100 and/or the handheld electronic device 102, may generate an alert indicating completion of the turn. As the turn is executed with eyes closed, this alert may include, for example, an audible indicator such as a tone and the like, and/or a physical indicator such as vibration and the like.

The system may then receive a second command, at block 560, to resume activity in the immersive virtual experience, at block 570, once the turn is complete. As described above, in some embodiments, the second command may be, for example, an opening of the user's eyes detected by, for example, the optical tracking device 165 of the HMD 100 as described above. In some embodiments, the second command may be, for example, a physical manipulation of the HMD 100 and/or the handheld electronic device, an audible command issued by the user, or other command that may be received by the system. Simply for ease of discussion and illustration, the second command will be considered to be the opening of the user's eyes detected by the optical tracking device 165 of the HMD 100 as described above.

Upon detection of the opening of the user's eyes, the user may resume activity in the virtual immersive environment at the same point at which the user left off (i.e., upon issuing the first command in response to the alert of the proximity of the physical boundary). In the situation in which the first command is the detection of the closing of the user's eyes, and the second command is the detection of the opening of the user's eyes, and the turn back into the physical space (away from the detected physical boundary) being executed with eyes closed, a user may physically re-orient in the real world space to allow for continued physical movement in the real world space and corresponding movement in the virtual world in a substantially seamless and continuous manner, with little to no perceived interruption in the immersive virtual experience, allowing for seemingly endless movement, even in a physical space that is limited by physical boundaries such as walls.

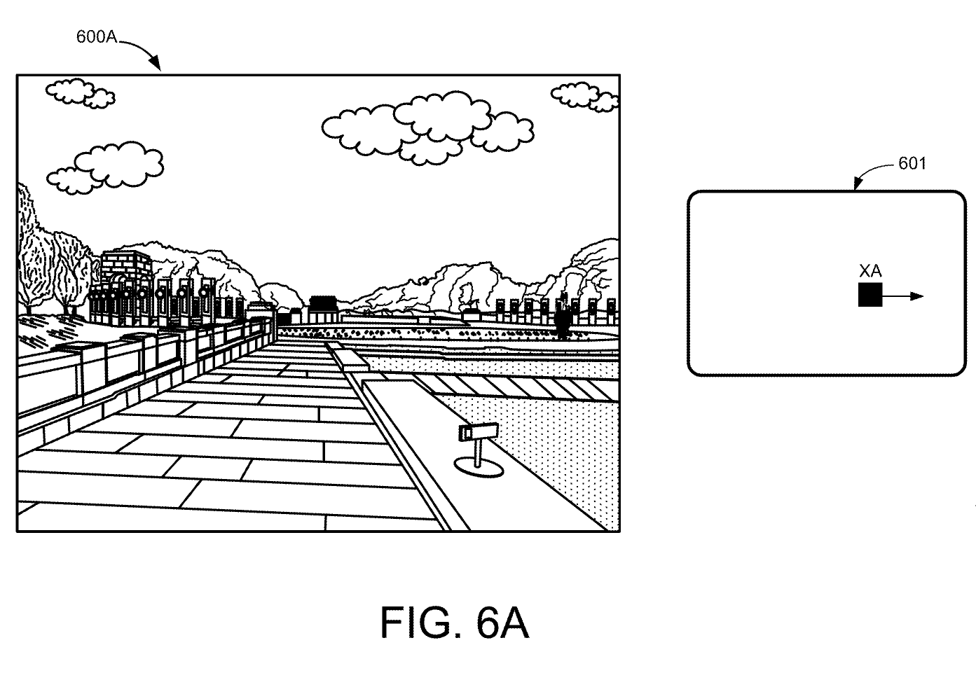

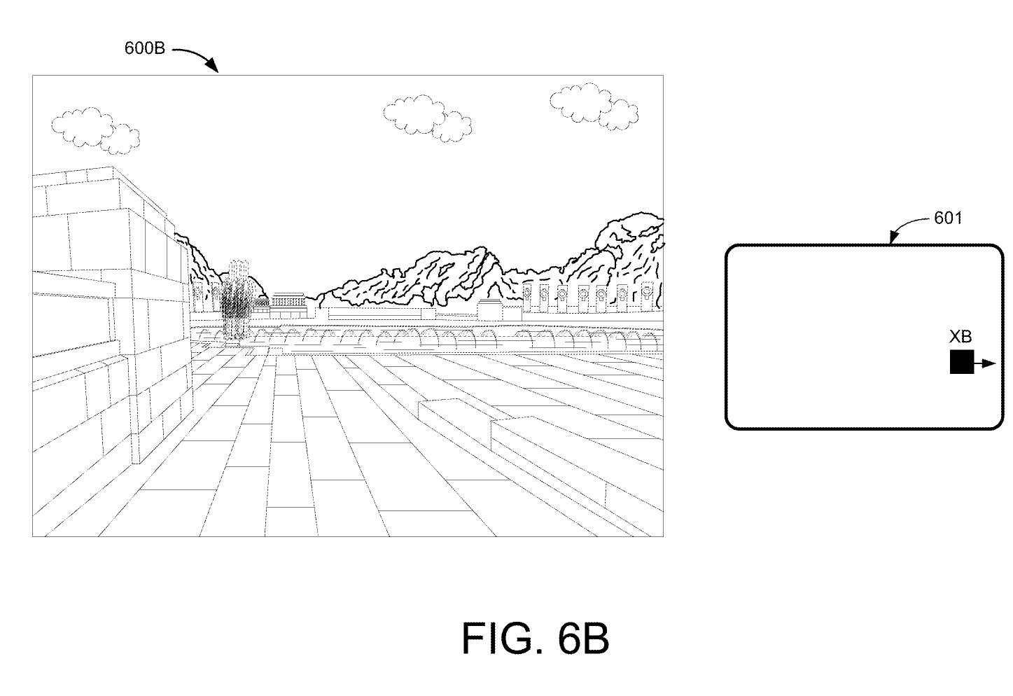

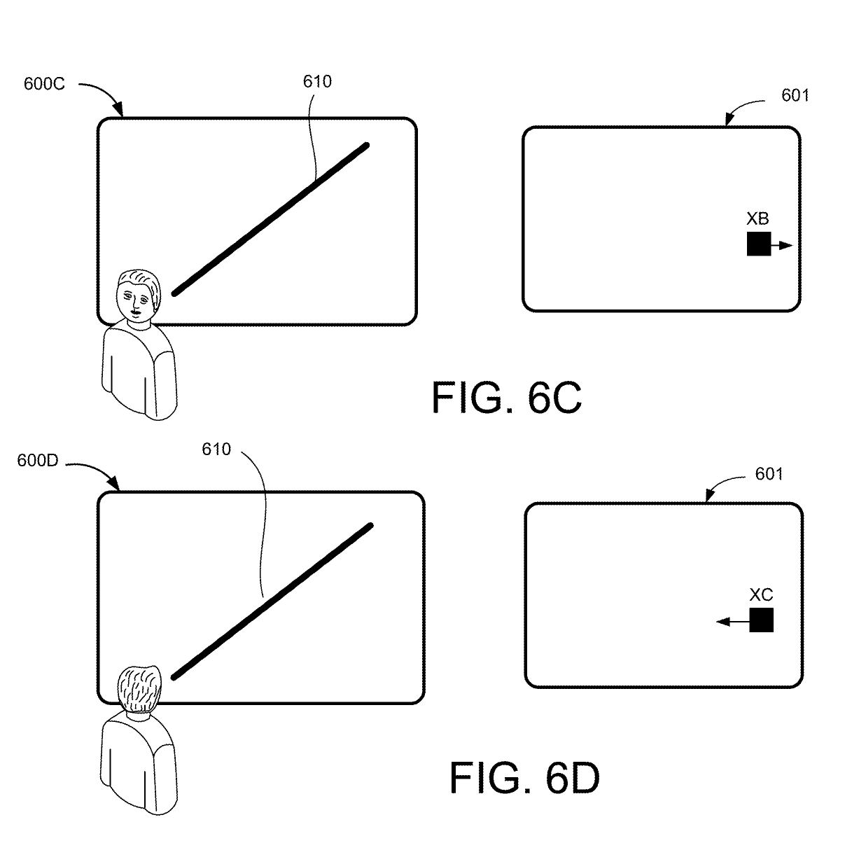

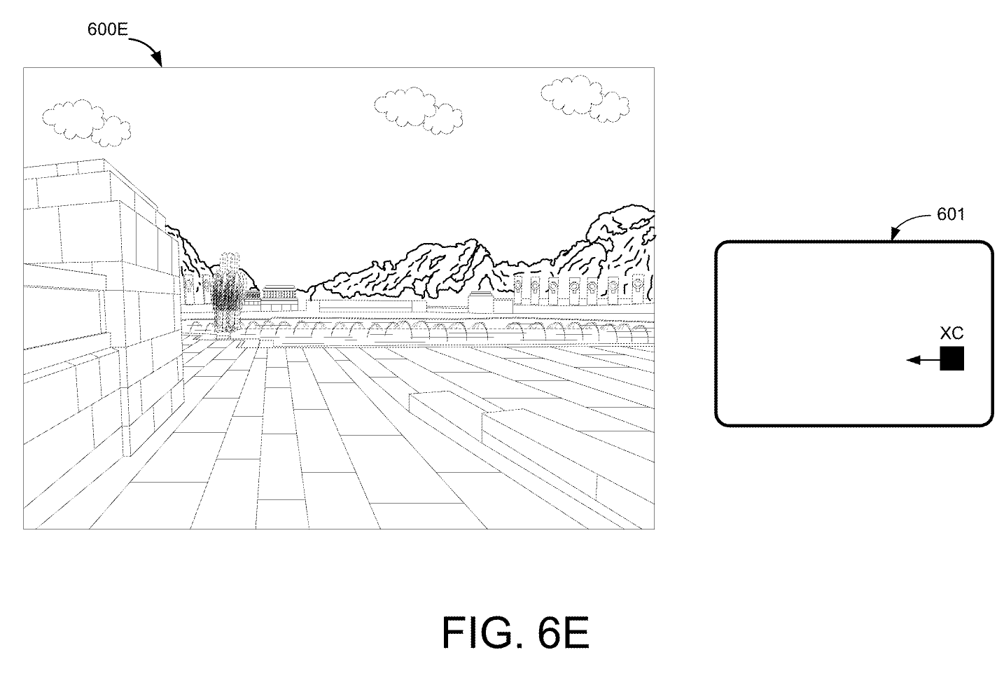

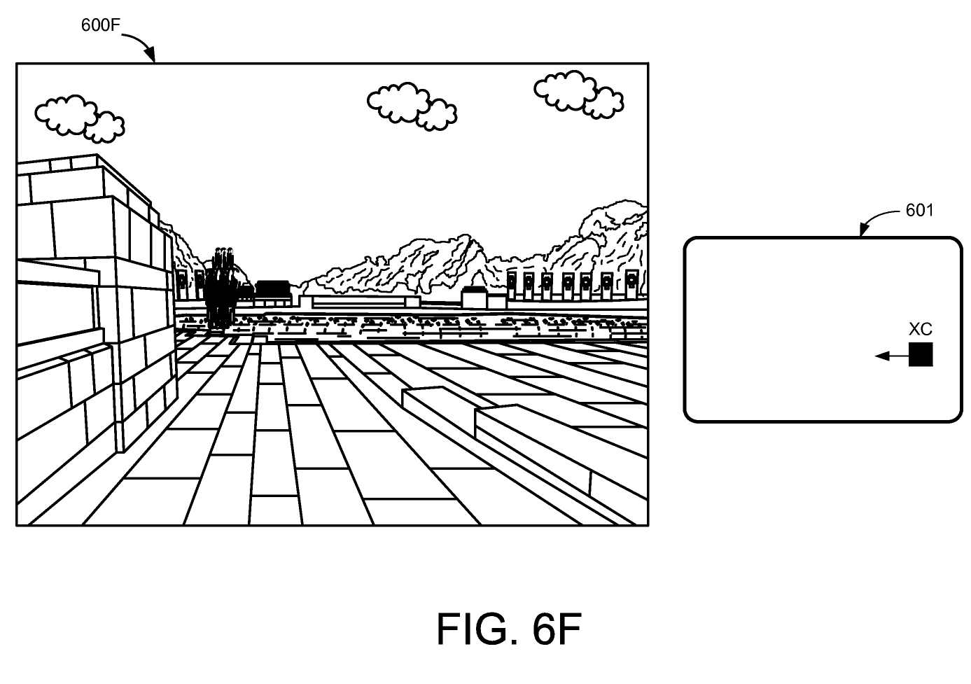

In some embodiments, the system, for example, the HMD 100, may display a guide to the user, to facilitate user re-orientation in the physical space. An example implementation of this type of alert to facilitate re-orientation is shown in FIGS. 6A-6F. An example of a scene 600A, as viewed by the user, for example, on the display 140 of the MMD 100, as the user moves in the real world space 601, and correspondingly in the virtual world scene 600A, is shown in FIG. 6A. As the user continues to move and approaches a wall defining a boundary of the real world space 601, or room, (either known or detected real time by the system), at position XB, the system may cause the scene to fade out, as shown in FIG. 6B. An example scene 600B viewed by the user, fading out as the user moves in the direction of the arrow in the real world space 601 and approaches the wall, is shown in FIG. 6B. In some embodiments, the fade out of the scene 600B may be accompanied by an audible alert and/or other physical alert as discussed above. The fade out of the scene 600B shown in FIG. 6B may warn the user that the user is, for example, within a predetermined range of the wall, or has essentially reached the wall.

Once the fade out is complete, a scene 600C including a guide 610 may be displayed, for example, in the form of a line or other visual alignment tool, as shown in FIG. 6C.

The user, at position XB in the real world space 601, may use the displayed guide 610 as in the scene 600D shown in FIG. 6D to physically re-orient in the real world space 601 to the position XC, to allow continued physical movement in the real world space 601 and corresponding movement in the virtual world scene. Once the user is oriented, or aligned, with the guide 610 as shown in FIG. 6D, and thus re-oriented in the physical space, the user may resume physical movement in the real world space 601, for example, in the direction of the arrow, and the virtual scene may fade back in as shown in FIG. 6E. The virtual scene 600E displayed as the virtual world fades back in is essentially the same as the virtual scene 600B displayed at the fade out, allowing the user to essentially pick up where the user left off in the immersive virtual experience. The user may resume activity in the virtual world in the fully displayed scene 600F shown in FIG. 6F.

In the example implementation shown in FIGS. 6A-6F, because the configuration of the physical real world space, as well as the user's position in the physical real world space may be known by the system, in some embodiments, the guide 610 may be displayed at an orientation which allows for the longest possible physical movement distance in the real world space before having to re-orient once again to continue physical movement in the real world space.

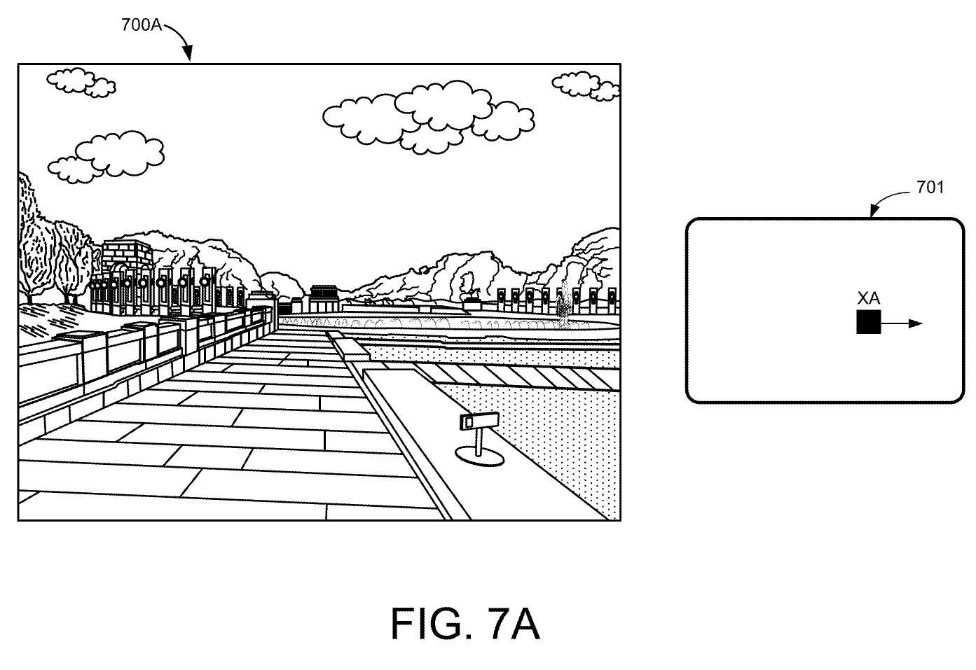

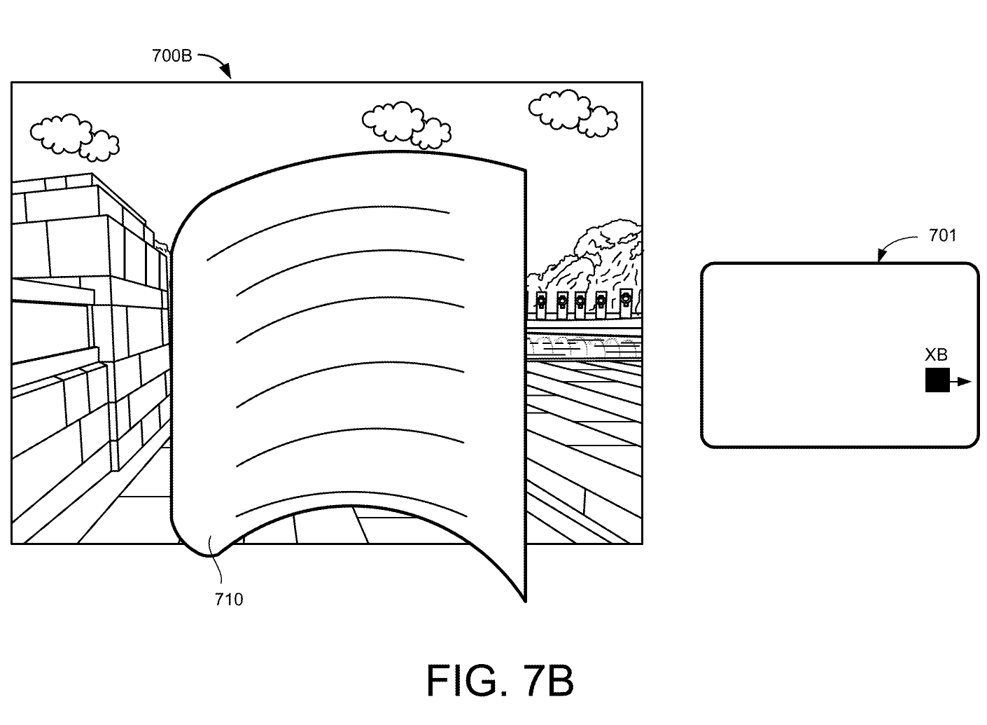

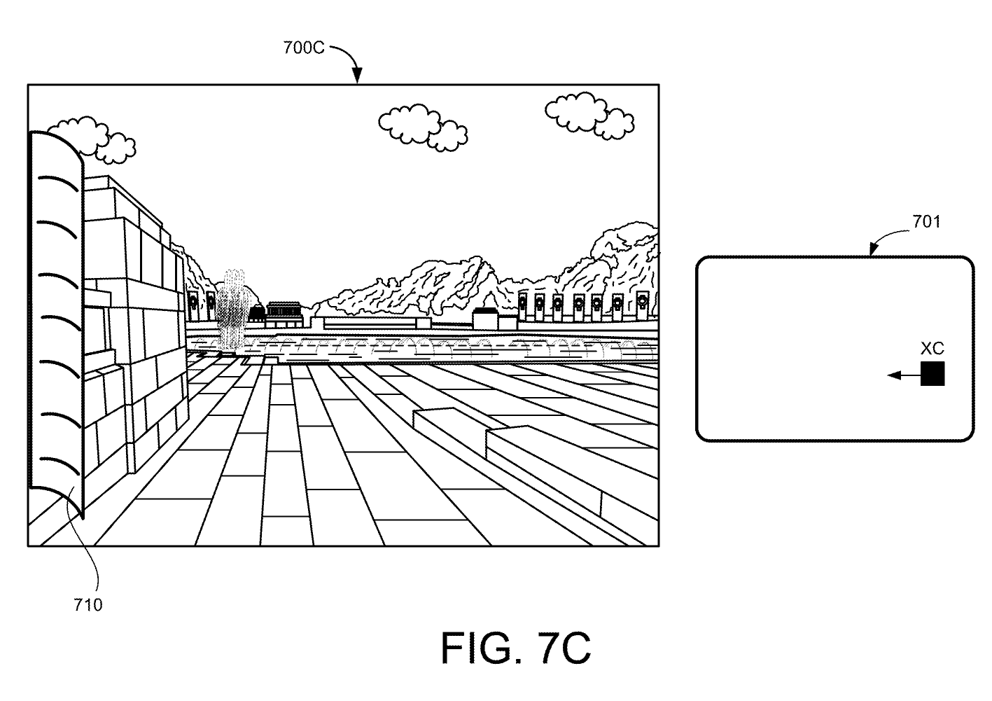

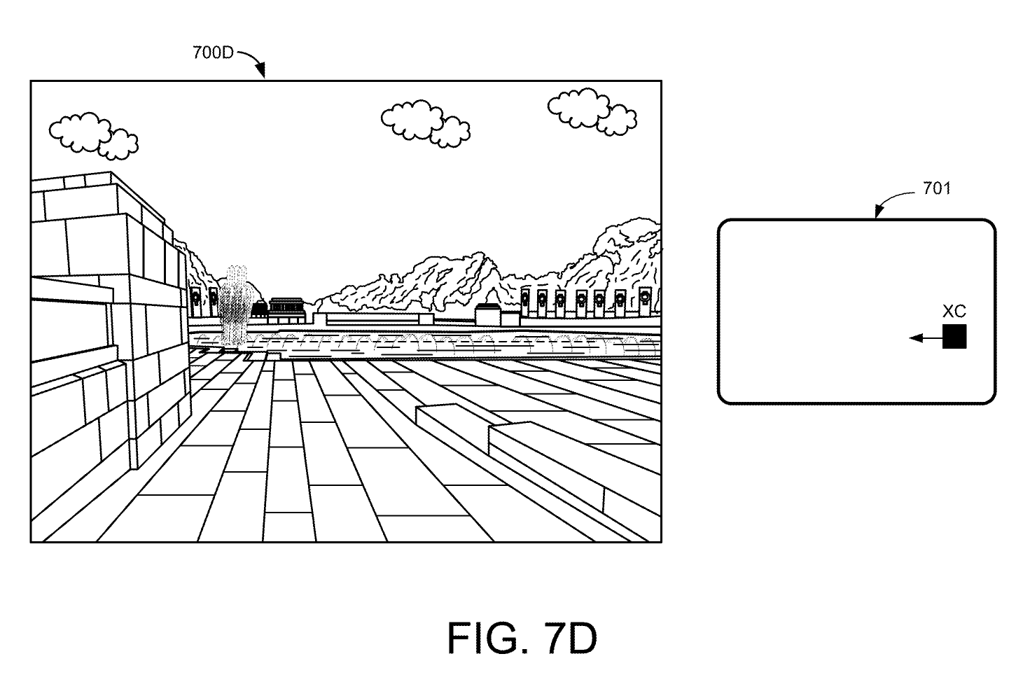

In some embodiments, the system, for example, the HMD 100, may display a guide to the user, to facilitate user re-orientation in the real world space space, in the form of a shape, and in particular, a three dimensional shape, which may naturally guide a turn of the user. An example implementation of this is shown in FIGS. 7A-7D. An example of a scene 700A, viewed by the user, for example, on the display 140 of the HMD 100 as the user moves in the real world space 701, and correspondingly in the virtual world scene 700A, is shown in FIG. 7A. As the user moves from the position XA in the direction of the arrow and approaches a wall defining a boundary of the real world space 701, or room, (either known or detected real time by the system) at position XB, the system may display an alert 710, or guide 710, in the form of a three dimensional shape which may guide the user's physical turn to re-orient in the real world space 701 to position XC. In the example shown in FIG. 7B, the alert 710 is displayed in the form of a guide having a cylindrical, or tubular, shape, and in particular, a section of a cylinder or tube so that the user's turn in the real world space may essentially follow a contour of the three dimensional shape of the guide 710. The guide 710 may provide an indication to the user that the virtual world is to re-orient, for example, approximately 180 degrees, so that the user may continue movement in the same virtual direction.

Upon encountering the guide 710 shown in FIG. 7B, the user may initiate a physical turn in the real world space. As the user turns and re-orients in the physical space, for example, from position XB to position XC, guided by the guide 710, for example, by the contour of the guide 710, the user's view may move along the surface of the guide 710. The user may continue to turn until passing an edge of the guide 710, and the scene 700C returns into the user's field of view, as shown in FIG. 7C. Passing the edge of the guide 710 may indicate completion of the turn, or completion of the shift in orientation, and allow the user to resume activity in the immersive virtual experience, as shown in FIG. 7D. That is, once the user is physically re-oriented in the real world space, the user may resume physical movement in the real world space, with the virtual scene 700D displayed as activity is resumed being essentially the same as the virtual scene 700B displayed when the guide 710 was encountered, allowing the user to essentially pick up where the user left off in the immersive virtual experience.

In the example implementation shown in FIGS. 7A-7D, because the configuration of the physical, real world space, as well as the user's position in the real world space may be known by the system, the system may size and/or position the guide 710 so that the edge of the guide indicating completion of the turn and/or re-orientation in the real world space may correspond to an orientation which allows for the longest possible physical movement distance in the physical space before having to re-orient once again to continue physical movement in the physical space.

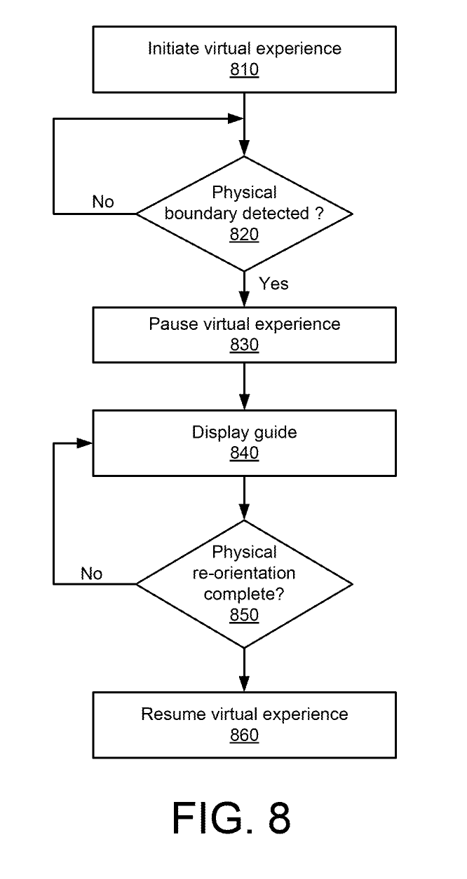

A flowchart of the processes described above with respect to FIGS. 6A-6F and 7A-7D is shown in FIG. 8. First, at block 810, an immersive virtual experience may be initiated by, for example, a first electronic device such as the HMD 100 shown in FIGS. 1 and 2A-2B, operably coupled with, for example, a second electronic device such as the handheld electronic device 102 shown in FIG. 1. As noted above, this operable coupling may be achieved through, for example, a wired connection or a wireless connection, to facilitate communication and exchange of information between the first and second electronic devices. As described above, in some embodiments, the virtual reality system may be operated, for example, in a real world space, or room, having physical boundaries such as walls, a floor and a ceiling.

When a physical boundary of the real world space, or room, is detected by the system, at block 820, the system may, at block 830, pause activity in/interaction with the immersive virtual experience and, at block 840, display a guide visible to the user to guide a turn, or physical re-orientation of the user in the real world space. As described above, the physical boundary may limit the ability to continue to move, or walk, in the physical space, or room, thus also limiting further mobility in the immersive virtual experience. As noted above, in some embodiments, the physical boundaries, or walls, of the real world space may be standard, or pre-set. In some embodiments, the physical boundaries, or walls, of the real world space may be set by the system upon initiation of the virtual immersive experience by, for example, scanning the real world space. In some embodiments, the physical boundaries, or walls, of the real world space may be detected by the system essentially real time with the system essentially continuously, or periodically, scanning the real world space.

In some embodiments, at block 840, the system may display a guide such as, for example, the guide 610 shown in FIGS. 6A-6F. As described above, in the example implementation shown in FIGS. 6A-6F, the virtual scene may fade out as the guide 610 is displayed, and the virtual scene may fade back in and the guide 610 may fade out as the turn, or re-orientation is completed upon the user's alignment with the guide 610.

In some embodiments, at block 840, the system may display a guide such as, for example, the guide 710 shown in FIGS. 7A-7D. As described above, in the example implementation shown in FIGS. 7A-7D, the guide 710 may take the form of, for example, a three dimensional shape, with a contour of the three dimensional shape guiding the turn or re-orientation of the user in the real world space, and a terminal edge of the three dimensional shape marking completion of the turn or re-orientation in the real world space.

The system may detect, at block 850, completion of the turn, or re-orientation, of the user in the real world space, and interactive activity in the immersive virtual experience may resume, at a point at which the user left off. In some embodiments, completion of the turn may be detected by, for example, one or more sensors in the HMD 100 and/or one or more sensors in the handheld electronic device 102. For example, in some embodiments, a gyroscope and/or an accelerometer of the HMD 100 and/or the handheld electronic device 102 either alone, or together with, for example, a camera of the HMD 100 and/or a camera of the handheld electronic device 102, and/or other cameras and sensors positioned throughout the real world space, may detect a position and orientation, and changes in position and/or orientation of the user to detect, at block 850, whether or not a turn, or re-orientation of the user has been completed. In some embodiments, completion of the turn, or re-orientation, of the user in the real world space may be detected in response to a user manipulation of the HMD 100 and/or the handheld electronic device.

As discussed above, at block 860, the user may resume interactive activity in the virtual immersive experience essentially seamlessly, at essentially the same point at which the user left off.

In a system and method, in accordance with embodiments as broadly described herein, a physical re-orientation of a user in a real world space may allow for seemingly endless corresponding movement, and in particular, forward motion associated with walking, in a virtual world, while avoiding disorientation and discomfort that may be associated with a physical and/or visual mismatch in position, orientation, and movement between the real world and the virtual world.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device (computer-readable medium), for processing by, or to control the operation of, data processing apparatus, e.g., a programmable processor, a computer, or multiple computers. Thus, a computer-readable storage medium can be configured to store instructions that when executed cause a processor (e.g., a processor at a host device, a processor at a client device) to perform a process.

A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT), a light emitting diode (LED), or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

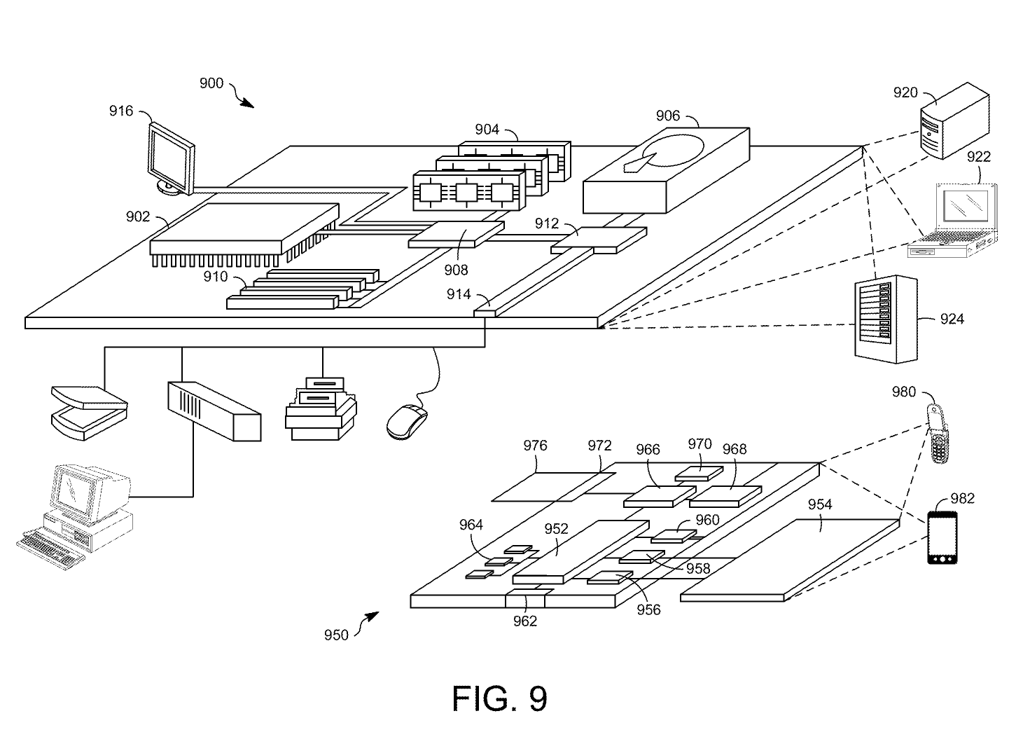

FIG. 9 shows an example of a generic computer device 900 and a generic mobile computer device 950, which may be used with the techniques described here. Computing device 900 is intended to represent various forms of digital computers, such as laptops, desktops, tablets, workstations, personal digital assistants, televisions, servers, blade servers, mainframes, and other appropriate computing devices. Computing device 950 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. The processor 902 can be a semiconductor-based processor. The memory 904 can be a semiconductor-based memory. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provide as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, or memory on processor 952, that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, various modifications may be made without departing from the spirit and scope of embodiments as broadly described herein.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method, comprising:
generating a virtual world environment within an audio visual device;
detecting, at the audio visual device, a physical boundary in a real world environment in response to move of the audio visual device within the real world environment;
generating an alert in response to the detecting of the physical boundary; and
pausing activity in the virtual world environment during physical re-orientation of the audio visual device within the real world environment; and
resuming activity in the virtual world upon completion of the re-orientation of the audio visual device within the real world environment.

2. The method of claim 1, wherein generating an alert in response to the detection of the physical boundary includes displaying a virtual grid on a display of the audio visual device, the virtual grid providing an indication of proximity of a user to the detected physical boundary.

3. The method of claim 2, wherein the pausing activity in the virtual world environment includes:
receiving a first command in response to the alert; and
pausing activity in the virtual world environment in response to the first command.

4. The method of claim 3, wherein the pausing activity in the virtual world environment also includes:
receiving a second command after pausing activity in the virtual world; and
resuming activity in the virtual world environment in response to the second command.

5. The method of claim 4, wherein
receiving a first command includes detecting, by an optical tracking device of the audio visual device, a closing of eyes of a user, and
receiving a second command includes detecting, by the optical tracking device, an opening of the eyes of the user.

6. The method of claim 5, wherein re-pausing activity in the virtual world environment during a physical re-orientation of the audio visual device in the real world environment includes:
pausing the activity in the virtual world environment at a beginning portion of an eyes closed period, the eyes closed period beginning at the detection of the closing of the eyes of the user and ending the opening of the eyes of the user; and
resuming the activity in the virtual world environment at an end portion of the eyes closed period, at the same point at which activity was paused in the virtual world environment,
wherein the re-orientation in the real world environment includes a physical re-orientation of a user in the real world environment during the eyes closed period while activity in the virtual world environment is paused.

7. The method of claim 6, further comprising:
detecting that the physical re-orientation is complete; and
generating another alert indicating completion of the re-orientation.

8. The method of claim 1, wherein generating an alert includes generating at least one of a visual alert, an audible alert or a tactile alert.

9. The method of claim 1, wherein generating an alert includes:
displaying a virtual guide on a display of the audio visual device; and
guiding a physical change in user orientation in the real world environment based on an orientation of the virtual guide displayed on the display.

10. The method of claim 9, wherein displaying a virtual guide includes displaying the virtual guide as an overlay on the virtual world environment generated by the audio visual device.

11. The method of claim 9, wherein displaying a guide includes:
fading out the virtual world environment displayed on the display; and
displaying the guide on the display.

12. The method of claim 11, wherein guiding a change in user orientation in the real world environment includes:
detecting and tracking a position and orientation of the user with respect to the virtual guide as the user changes position and orientation in the real world environment relative to the virtual guide; and
fading out the display of the guide and fading the virtual world environment back in when alignment of the user with the guide is detected.

13. The method of claim 9, wherein guiding a change in user orientation in the real world environment includes:
detecting and tracking a position and orientation of the user with respect to the virtual guide as the user changes position and orientation in the real world environment relative to the virtual guide; and
detecting completion of the physical re-orientation of the user in the real world environment as the user reaches a terminal edge of the virtual guide.

14. The method of claim 1, wherein generating a virtual world environment within an audio visual device i includes operating a head mounted display device, operably coupled to a handheld electronic device, in the real world environment, to generate the virtual world environment.

15. An audio visual device, including:
a head mounted electronic device configured to be operably coupled with a handheld electronic device, the head mounted electronic device including:
a display;
an optical tracking device; and
a control system controlling operation of the head mounted electronic device to:
display a virtual world environment on the display;
detect a physical boundary in the real world environment;
generate an alert in response to the detection of the physical boundary; and
re-orient the virtual world environment in coordination with a physical re-orientation of the head mounted electronic device in the real world environment.

16. The device of claim 15, wherein the alert includes a virtual grid displayed as an overlay on the virtual world environment displayed on the display, a scale of the grid corresponding to a physical proximity of a user of the audio visual device to the detected physical boundary.

17. The device of claim 15, wherein, in response to detection of a closing of a user's eyes by the optical tracking device, the control system is configured to pause activity in the virtual world environment, and, in response to detection of an opening of the user's eyes by the optical tracking device, the control system is configured to resume activity in the virtual world environment at the same point at which activity was paused in the virtual world environment.

18. The device of claim 17, wherein the physical re-orientation in the real world environment is initiated after detection of the closing of the user's eyes and is completed prior to detection of the opening of the user's eyes.

19. The device of claim 15, wherein the alert includes a virtual guide displayed on the display, either as an overlay on the virtual world environment displayed on the display, or instead of the virtual world environment, and wherein the control system is configured to
detect and track a position and orientation of the user with respect to the virtual guide as the user changes position and orientation in the real world environment relative to the virtual guide; and
detect completion of the physical re-orientation of the user in the real world environment as the user is aligned with the virtual guide, or reaches a terminal edge of the virtual guide.

20. A non-transitory computer-readable storage medium storing instructions that, when executed, cause a computing device to perform a process, the instructions comprising instructions to:
operate a head mounted electronic device within physical boundaries of a real world environment to generate an immersive virtual environment;
detect a physical boundary of the real world environment;
generate an alert in response to the detection of the physical boundary, the alert including a virtual visual indicator displayed on a display of the head mounted electronic device;
pause activity in the virtual world environment in response to detection of initiation of a physical re-orientation of the head mounted electronic device in the real world space;
track a physical position and orientation of the head mounted electronic device in the real world space; and
resume activity in the virtual world environment, at the same point at which activity was paused, in response to detection of completion of a physical re-orientation of the head mounted electronic device in the real world space.
